(19) United States
(12) Patent Application Publication
(10) Pub. No.: US 2001/0003966 A1
(43) Pub. Date: Jun. 21, 2001

(54) Film forming apparatus

(75) Inventors: Takahiro Kitano, Kumamoto (JP); Masateru Morikawa, Kumamoto (JP); Yukihiko Esaki, Kumamoto (JP); Nobukazu Ishizaka, Kumamoto (JP); Norihisa Koga, Kumamoto (JP); Kazuhiro Takeshita, Kumamoto (JP); Hirofumi Ookuma, Kumamoto (JP); Masami Akimoto, Kumamoto (JP)

Correspondence Address: RADER, FISHMAN & GRAUER PLLC, 1233 20th Street, N.W., Suite 501, Washington, DC, 20036, US

(73) Assignee: TOKYO ELECTRON LIMITED

(21) Appl. No.: 09/735,902

(22) Filed: Dec. 14, 2000

(30) Foreign Application Priority Data
Dec. 16, 1999 (JP) JP11-357874
Dec. 17, 1999 (JP) JP11-359565

(51) Int. Cl. B05C 11/00; B05C 13/00; B05C 13/02

(52) U.S. Cl. 118/70; 118/300

(57) ABSTRACT

A discharge nozzle in a film forming apparatus of the present invention includes a substantially cylindrical support member and a thin plate or a thin plate portion supported on a face on a substrate side of the support member and closing the face on the substrate side, and a discharge port for discharging a coating solution is provided in the thin plate or the thin plate portion. It is possible to form a smaller discharge port in the thin plate or the thin plate portion by laser processing, punching, or the like than that obtainable by conventional injection molding processing. An amount of discharge and a discharge area on the substrate of the coating solution can be controlled more precisely. The film forming apparatus of the present invention includes a cleaning device for cleaning the discharge nozzle which includes a cleaning solution jet port for jetting a cleaning solution for cleaning to the discharge port of the discharge nozzle and a suction port for sucking an atmosphere in the vicinity of the discharge port. Contaminants adhering to the discharge port are removed more completely than before. Accordingly, the cleaning can be conducted effectively even if the diameter of the discharge port is very small. The suction port can suck and drain properly the cleaning solution jetted to the discharge port, preventing scatter of the cleaning solution and contamination around the discharge port.

### BACKGROUND OF THE INVENTION

1. Field of the Invention

The present invention relates to a film forming apparatus for a substrate.

2. Description of the Related Art

In a photolithography process in the semiconductor device fabrication processes, for example, resist coating treatment in which a resist solution is applied to the front face of a wafer to form a resist film, exposure processing in which the wafer is exposed in a pattern, developing treatment in which development is performed for the exposed wafer, and the like are performed to form a predetermined circuit pattern on the wafer.

As a discharge nozzle used in an apparatus for performing the above-described resist coating treatment, used is a tapering one made of a resin generally. Because fabricated through the use of injection molding processing, this tapering discharge nozzle has a hole diameter of about 2 mm at present because of the limitations of the processing technique.

However, a smaller line width of circuit pattern has been required as semiconductor technology has advanced in recent years, and thus it has been desired to form a smaller discharge port because a diameter of the discharge port of the discharge nozzle equals a diameter of a flow of the coating solution to be discharged. Further, a small-diameter nozzle is preferable to suppress waste discharge of the resist solution.

The aforesaid resist coating treatment is performed by discharging the resist solution from a coating solution discharge nozzle to the wafer, and, unless this coating solution discharge nozzle is cleaned as required, it is contaminated with the resist solution or the like resulting in changes in diameter.

Therefore, conventionally, the coating solution discharge nozzle is cleaned with a cleaning solution such as a solvent or the like, the conventional cleaning being performed by soaking the discharge port of the discharge nozzle in a cleaning bath storing the solvent.

However, if the diameter of the discharge port of the nozzle is very small as described above, the conventional cleaning method can not clean the discharge port, leaving minute contaminants on the discharge port, and resulting in inadequate application of the resist solution because of changes in discharge direction and discharge pressure of the resist solution.

### SUMMARY OF THE INVENTION

The present invention is designed in view of the above-described points, and the first object of the present invention is to provide a film forming apparatus including a discharge nozzle of which a discharge port for discharging a coating solution is easily made smaller in diameter than before.

The second object of the present invention is to remove minute contaminants adhering to the discharge port more completely even if the discharge port of the solution discharge nozzle is very small.

To attain the first object, according to the first aspect of the present invention, in the film forming apparatus of the present invention, the discharge nozzle includes a substantially cylindrical support member and a thin plate supported on a face on a substrate side of the support member and closing the face on the substrate side, and the thin plate is provided with a discharge port for discharging the coating solution to the substrate.

According to the second aspect of the present invention, in the film forming apparatus of the present invention, the discharge nozzle includes a substantially cylindrical support member and a thin plate portion, disposed on a face on a substrate side of the support member, for closing the face on the substrate side, the thin plate portion is integrated with a holding member which is attachable and detachable to/from the support member, and the thin plate portion is provided with a discharge port for discharging the coating solution to the substrate.

According to the present invention, the coating solution passes through the support member to be discharged from the discharge port of the thin plate, and the thin plate can be formed with a smaller hole by laser processing, punching, or the like than that obtainable by conventional injection molding processing. Therefore, according to the present invention, it is possible to form a very small discharge port in the thin plate and to apply the coating solution from the discharge port. As a result, for example, even if the coating solution is discharge outside the substrate unintentionally, the amount of waste coating solution is smaller than before. Further, the discharge port can be decreased in diameter, thereby controlling the amount of discharge and the discharge area on the substrate of the coating solution more precisely.

An edge portion of a face on the substrate side at the discharge port may be formed in tapered shape such that the discharge port increases in diameter as it comes closer to the substrate. An edge portion of a face on the opposite side to a face on the substrate side of the discharge port may be formed such that the discharge port decreases in diameter as it comes closer to the substrate. The fabrication processing suppresses surface tension affecting the discharge.

A recessed portion may be formed in a peripheral portion of an edge portion of the face on the substrate side at the discharge port. The existence of the recessed portion suppresses effects by change in surface tension caused by the coating solution adhering to the discharge port.

The discharge port is subjected to water repellent treatment to the coating solution, whereby the coating solution is smoothly discharged from the discharge port to supply a consistent and predetermined coating solution to the substrate.

A plurality of the discharge ports may exist. This can increase the amount of discharge to the substrate.

The discharge nozzle is made movable in a horizontal direction relative to the substrate, whereby the nozzle discharges the coating solution while moving above the substrate, with the result that the coating solution can be applied on the substrate in the manner of a so-called “continuous stroke”. The discharge of the coating solution in the manner of the continuous stroke makes it possible to form a coating film with a uniform thickness without unevenness on the entire face of the substrate.

A film forming apparatus characterized by including a temperature regulator capable of adjusting temperature of the thin plate or the thin plate portion, is provided. This makes it possible to keep the temperature of the thin plate at a predetermined temperature, thereby keeping the diameter of the discharge port formed in the thin plate or the thin plate portion constant. Further, the temperature of the coating solution flowing through the discharge port can be kept at a predetermined temperature, stabilizing the viscosity and surface tension of the coating solution.

A flow path, which is provided in the support member or the holding member, through which a temperature-adjustable fluid flows can keep the temperature of the thin plate, the thin plate portion, or the coating solution at a predetermined temperature.

A coating solution which is diluted, for example, with a solvent or the like to be lower in viscosity than the coating solution applied by the conventional spin coating method is suitable for the coating solution used in the present invention. For example, a viscosity ranging from 2 cP to 7 cP is preferable. Concretely, in the case where the coating solution is for forming a photoresist, an amount (percentage by volume) of a photoresist film formation component in the coating solution is suitable from 1.0% to 7.0% of the coating solution, in which about 1.5% is especially suitable. Further, in the case where the coating solution is for forming a layer insulating film, an amount of a layer insulating film formation component in the coating solution is suitable from 1.0% to 8.0% of the coating solution, in which about 4.0% is especially suitable.

To attain the second object of the present invention, according to the third aspect of the present invention, the film forming apparatus of the present invention is a film forming apparatus for supplying a coating solution from a discharge nozzle to a substrate to form a film on a front face of the substrate includes a cleaning device for cleaning the discharge nozzle, the cleaning device including a cleaning solution jet port for jetting a cleaning solution for cleaning to a discharge port of the discharge nozzle and a suction port for sucking an atmosphere in the vicinity of the discharge port.

By jetting the cleaning solution directly to the discharge port of the discharge nozzle, contaminants adhering to the discharge port are removed more completely than before with the help of the jetting pressure of the cleaning solution. Accordingly, the removal can be conducted effectively even if the diameter of the discharge port is very small. The suction port can suck and drain properly the cleaning solution jetted to the discharge port, preventing scatter of the cleaning solution and contamination around the discharge port. Moreover, the suction generates airflow, thereby speeding up the drying of the discharge port. Incidentally, the cleaning solution also means the solvent of the coating solution in the present invention.

According to the fourth aspect of the present invention, the film forming apparatus of the present invention is a film forming apparatus for supplying a coating solution from a discharge nozzle to a substrate to form a film on a front face of the substrate includes a cleaning device for cleaning the discharge nozzle, the discharge nozzle including a substantially cylindrical support member, a thin plate provided on a lower face of the support member for closing the lower face, and a discharge port formed in the thin plate, the cleaning device having a cleaning block including a flat close contact portion closely contacting the thin plate at an upper end, wherein the cleaning block is provided with a cleaning solution jet port for jetting a cleaning solution toward the discharge port of the discharge nozzle and a suction port for sucking an atmosphere in the vicinity of the discharge port when the cleaning block closely contacts the thin plate.

Since a thin plate easy to be processed is used for the solution discharge nozzle, it is possible to form a smaller discharge port. Further, the cleaning is performed with the cleaning block including the cleaning solution jet port being closely attached to the thin plate, making it possible to jet the cleaning solution directly to the discharge port, so that minuter contaminants are removed more completely even if the discharge port is very small.

The discharge nozzle may include a holding member for fixing the thin plate to the support member from the outside, the cleaning device may have a cleaning block including a flat close contact portion closely contacting the holding member at an upper end, wherein the cleaning block may be provided with a cleaning solution jet port for jetting a cleaning solution toward the discharge port of the discharge nozzle and a suction port for sucking an atmosphere in the vicinity of the discharge port when the cleaning block closely contacts the holding member. The cleaning device may have a cleaning block including protrusions on a face contacting the thin plate, and the cleaning block may be provided with a cleaning solution jet port for jetting a cleaning solution toward the discharge port of the discharge nozzle and a suction port for sucking an atmosphere in the vicinity of the discharge port when the cleaning block contacts the thin plate via the protrusions.

The provision of the protrusions on the cleaning block produces a gap between the cleaning block and the holding member when the cleaning block contacts the holding member. Thus, when the suction port sucks the surrounding atmosphere, it flows into the discharge port through the gap to speed up the drying. Accordingly, even if, for example, the inert gas for drying such as nitrogen gas or the like is not supplied especially, the drying of the discharge port is performed properly. It is preferable to arrange the protrusions in arc form to surround the discharge port in order to suppress the scatter of the cleaning solution from the gap.

The thin plate is realized, for example by being integrated with the holding member to be a thin plate portion in the holding member. In this case, the discharge port is formed in the thin plate portion. In the above case, a sealing member is interposed between the holding member and the close contact portion, thereby preventing the cleaning solution from scattering thereabout.

A cleaning recessed portion may be formed at the center in the top portion of the cleaning block, and the jet port and the suction port may be open in the cleaning recessed portion. A jet path leading to the jet port and a suction path leading to the suction port may be formed inside the cleaning block. The cleaning block may separately include a gas supply mechanism for supplying an inert gas for drying toward the discharge port of the discharge nozzle, and a supply port of the inert gas may be open in the cleaning recessed portion. A jet path leading to the jet port, a suction path leading to the suction port, and a supply path leading to the supply port may be formed inside the cleaning block. The jet port and the suction port may be formed at positions opposing the discharge port of the discharge nozzle.

The discharge nozzle may be movable relative to the substrate, and the cleaning block may be disposed within a range of motion of the discharge nozzle and vertically movable. The discharge nozzle may be movable relative to the substrate, and the cleaning block may be held by a carrier mechanism movable within a range of motion of the discharge nozzle, and the carrier mechanism may be vertically movable.

The cleaning solution, to which ultrasound is applied or air bubbles are mixed, has a high cleaning effect. The cleaning solution may be intermittently jetted.

It is also suitable to include a diaphragm-type pump for supplying the coating solution to the discharge nozzle, a detecting function unit for detecting a change in forcing amount of the pump, and a cleaning controller for causing the cleaning device to start cleaning based on a detection result by the detecting function unit.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is an explanatory view of a coating and developing system including a resist coating unit according to this embodiment as viewed from the plane;

FIG. 2 is a front view of the coating and developing system in FIG. 1;

FIG. 3 is a rear view of the coating and developing system in FIG. 1;

FIG. 4 is an explanatory view of a vertical cross section of the resist coating unit according to this embodiment;

FIG. 5 is an explanatory view of a horizontal cross section of the resist coating unit according to this embodiment;

FIG. 6 is an explanatory view showing a vertical cross section of a discharge nozzle used in the resist coating unit;

FIG. 7 is an enlarged view of a sectional view of a nozzle plate of the discharge nozzle;

FIG. 8 is an explanatory view showing a coating route of the resist solution in this embodiment;

FIG. 9 is an enlarged view of a vertical end face schematically showing a nozzle plate having another hole shape;

FIG. 10 is an explanatory view showing a vertical section of a discharge nozzle having a flow path of a fluid for adjusting temperature;

FIG. 11 is an explanatory view showing a vertical cross section of a discharge nozzle having a thin part in place of the nozzle plate;

FIG. 12 is a perspective view showing an appearance in which two discharge nozzles each having an outer body with side faces in box shape are securely connected;

FIG. 13 is an explanatory view of a vertical cross section of a resist coating unit according to another embodiment;

FIG. 14 is an explanatory view of a horizontal cross section of the resist coating unit in FIG. 13;

FIG. 15 is a perspective view showing the positional relation between a discharge nozzle and a cleaning block;

FIG. 16A is a plan view of the cleaning block used for a cleaning device for the discharge nozzle, and FIG. 16B is an explanatory view of a vertical cross section thereof;

FIG. 17 is an explanatory view of a vertical cross section of the discharge nozzle and the cleaning block when cleaning;

FIG. 18A is a plan view of a cleaning block of another embodiment, and FIG, 18B is an explanatory view of a vertical cross section thereof;

FIG. 19 is an explanatory view of a vertical cross section of a cleaning block showing another embodiment;

FIG. 20 is an explanatory view schematically showing a resist solution supply mechanism when supplying the resist solution to the discharge nozzle using a diaphragm-type pump; and

FIG. 21 is a vertical sectional view showing an appearance of a discharge nozzle without a thin plate in close contact with a cleaning block via a sealing member.

### DETAILED DESCRIPTION OF THE PREFERRED EMBODIMENT

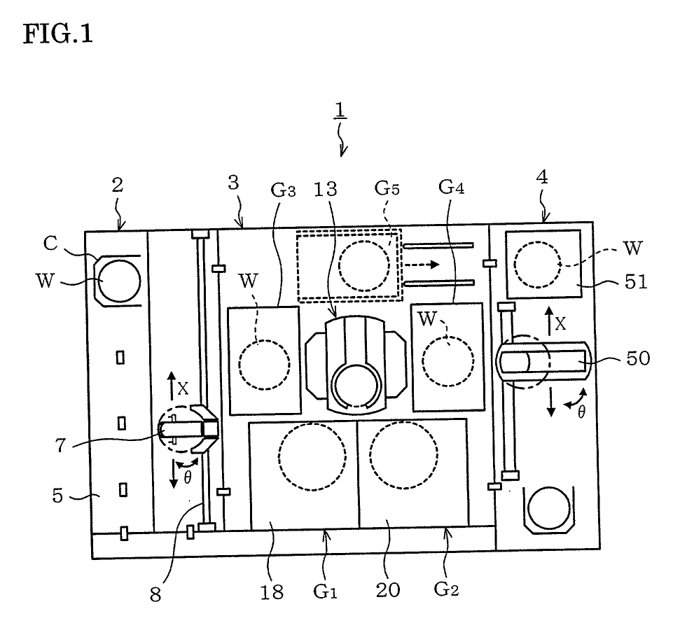

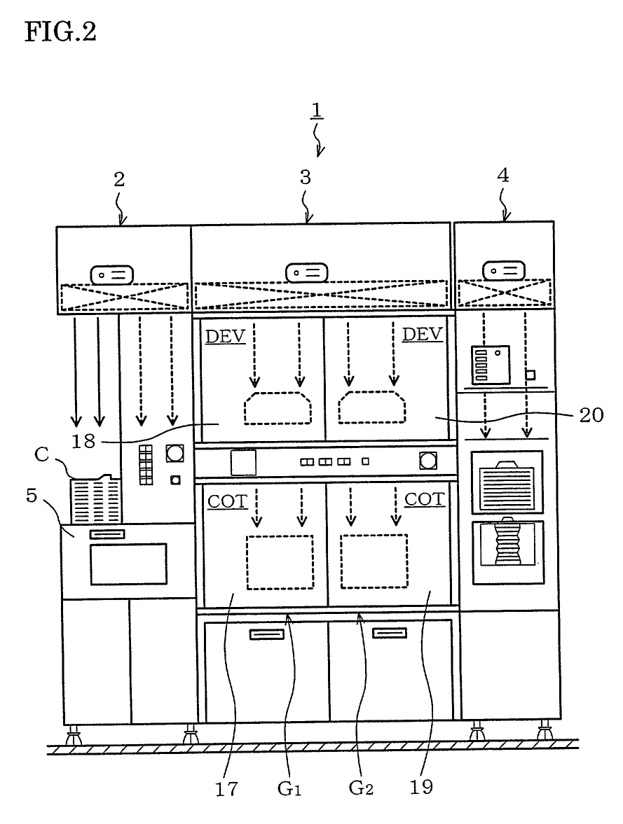

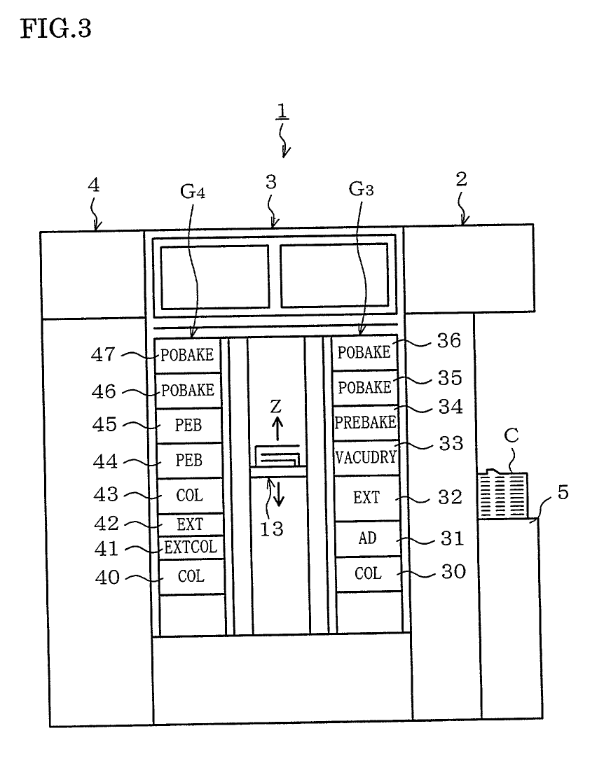

Hereinafter, preferable embodiments of the present invention will be described. FIG. 1 is a plan view of a coating and developing system 1 including a resist coating unit according to this embodiment, FIG. 2 is a front view of the coating and developing system 1, and FIG. 3 is a rear view of the coating and developing system 1.

The coating and developing system 1 has a configuration, as shown in FIG. 1, in which a cassette station 2 for carrying, for example, 25 wafers W, as a unit of cassette, from/to the outside into/out of the coating and developing system 1 and carrying the wafer W into/out of a cassette C, a processing station 3 in which various kinds of processing and treatment units each for performing predetermined processing or treatment for the wafers W one by one in coating and developing steps are multi-tiered, and an interface section 4 for delivering the wafer W to/from an aligner, not shown, provided adjacent to the processing station 3 are integrally connected.

In the cassette station 2, a plurality of cassettes C can be mounted at predetermined positions on a cassette mounting table 5 which is a mounting portion in a line in an X-direction (a vertical direction in FIG. 1). A wafer carrier 7 transportable in the direction of arrangement of the cassettes (the X-direction) and in the direction of arrangement of the wafers W housed in the cassette C (a Z-direction; a vertical direction) is provided to be movable along a carrier guide 8 so as to selectively get access to each cassette C.

The wafer carrier 7 includes an alignment function of aligning the wafer W. The wafer carrier 7 is configured to get access also to an extension unit 32 included in a third processing unit group G3 on the processing station 3 side as described later.

In the processing station 3, a main carrier unit 13 is provided at the central portion thereof, and various kinds of processing and treatment units are multi-tiered around the main carrier unit 13 to form processing unit groups. In the coating and developing system 1, four processing unit groups G1, G2, G3, and G4 are arranged, the first and second processing unit groups G1 and G2 are disposed on the front side of the coating and developing system 1, the third processing unit group G3 is disposed adjacent to the cassette station 2, and the fourth processing unit group G4 is disposed adjacent to the interface section 4. Further, a fifth processing unit group G5 shown by a broken line can be additionally disposed on the rear side as an option.

In the first processing unit group G1, for example, as shown in FIG. 2, a resist coating unit 17 according to this embodiment and a developing unit 18 for supplying a developing solution to the wafer W to thereby treat it are two-tiered in order from the bottom. In the second processing unit group G2, a resist coating unit 19 and a developing unit 20 are similarly two-tiered in order from the bottom.

In the third processing unit group G3, for example, as shown in FIG. 3, a cooling unit 30 for cooling for the wafer W, an adhesion unit 31 for enhancing fixedness between a resist solution and the wafer W, an extension unit 32 for allowing the wafer to wait therein, a vacuum drying unit 33 for vacuum drying a solvent in the resist solution, a pre-baking unit 34, post-baking units 35 and 36 each for performing heat treatment after developing treatment, and the like are, for example, seven-tiered from the bottom in order.

In the fourth processing unit group G4, for example, a cooling unit 40, an extension and cooling unit 41 for allowing the wafer W mounted thereon to cool by itself, an extension unit 42, a cooling unit 43, post-exposure baking units 44 and 45 each for performing heat treatment after exposure processing, post-baking units 46 and 47, and the like are, for example, eight-tiered from the bottom in order.

A wafer carrier 50 is provided at the central portion of the interface section 4. The wafer carrier 50 is configured to be movable in the X-direction (the vertical direction in FIG. 1) and in the Z-direction (the vertical direction) and rotatable in a θ-direction (a direction of rotation around a Z-axis) so as to get access to the extension and cooling unit 41 and the extension unit 42 included in the fourth processing unit group G4, a peripheral aligner 51, and the not shown aligner.

Next, the structure of the resist coating unit 17 will be explained in detail. The resist coating unit 17 employs a coating method in the manner of a so-called continuous stroke, in which a resist solution discharge mechanism for applying a resist solution applies the resist solution while moving relative to the wafer W.

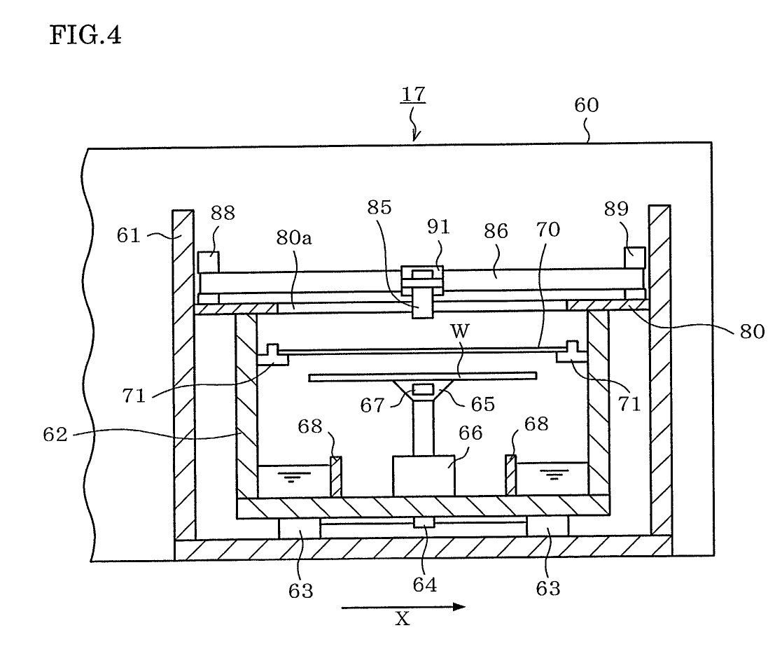

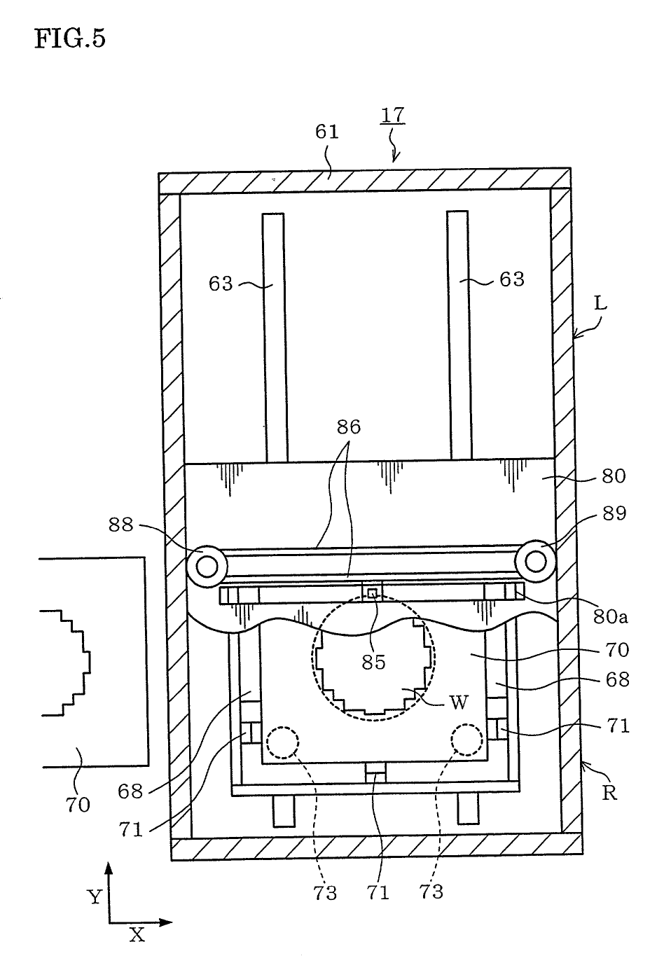

In the casing 60 of the resist coating unit 17, as shown in FIG. 4 and FIG. 5, a substantially box-shaped outer case 61 long in the Y-direction (the vertical direction in FIG. 5), and the top thereof is open. An inner case 62 in which the wafer W is processed is provided in the outer case 61. The inner case 62 has an open top and is configured to be movable on two rails 63 extending in the Y-direction provided on the bottom face of the outer case 61 by means of an inner case drive mechanism 64. Accordingly, the inner case 62 can move to a carriage portion L in a forward direction of the Y-direction (the upper side in FIG. 5) when the wafer W is carried into/out of the inner case 62, and the inner case 62 can move to a treatment portion R in a backward direction of the Y-direction (the lower side in FIG. 5) when the wafer W is subjected to coating treatment. Moreover, it becomes possible to move the inner case 62 in the Y-direction only by a predetermined distance at a predetermined timing even during application of the resist solution to the wafer W.

Further, a mounting table 65 for holding the wafer W by sucking it is provided in the inner case 62, and a rotation drive 66 for causing the mounting table 65 to freely rotate is provided under the mounting table 65. For example, an ultrasonic vibrator 67 is attached to the mounting table 65, thereby vibrating the mounting table 65 at a high frequency. On the bottom face of the inner case 62, provided is a solvent tank 68 for storing a solvent for maintaining the inside of the inner case 62 in a solvent atmosphere at a predetermined concentration.

Exhaust ports 73 are provided in the bottom face of the inner case 62 to maintain a predetermined solvent concentration around the wafer W by producing airflow in the inner case 62 by exhaust from the exhaust ports 73.

Furthermore, a mask member 70 for covering the wafer W to limit the range of application of the resist solution is disposed above the wafer W, and the mask member 70 is supported by mask support members 71 provided on inner walls of the inner case 62. The mask member 70 can be carried in the X-direction by means of a carrier mechanism not shown. Therefore, it becomes possible to allow the mask member 70 to wait at a cleaning portion on the backward side in the X-direction of the outer case 61 and to carry the mask member 70 onto the mask support members 71 in the inner case 62 by the aforesaid carrier mechanism after the inner case 62 holding the wafer W moves to the treatment portion R.

A lid body 80 for covering the treatment portion R side of the outer case 61 is securely attached to the aforesaid outer case 61, so that when the inner case 62 moves to the treatment portion R side, the lid body 80 covers the top of the inner case 62, making it easy to maintain a predetermined atmosphere. The lid body 80 is provided with a slit 80a extending in the X-direction, and a discharge nozzle 85 as a discharge nozzle described later moves in the slit 80a in the X-direction.

As described above, in the slit 80a of the lid body 80 provided on the treatment portion R side of the outer case 61, the discharge nozzle 85 according to the present invention is provided to be capable of discharging the resist solution to the wafer W thereunder. The discharge nozzle 85 is secured to a holder 91 of a nozzle holding member, and the holder 91 is mounted to a timing belt 86 extending in the X-direction. The timing belt 86 runs between pulleys 88 and 89 provided on the lid body 80, and the pulley 88 is rotated forward and backward by a rotation mechanism such as a motor not shown. As a result, the discharge nozzle 85 can reciprocate in the slit 80a of the lid body 80 by means of the timing belt 86. Thus, the discharge nozzle 85 discharges the resist solution while moving relative to the wafer W thereunder, and further the inner case 62 moves intermittently in the Y-direction, thereby supplying the resist solution to the wafer W in the manner of a so-called continuous stroke.

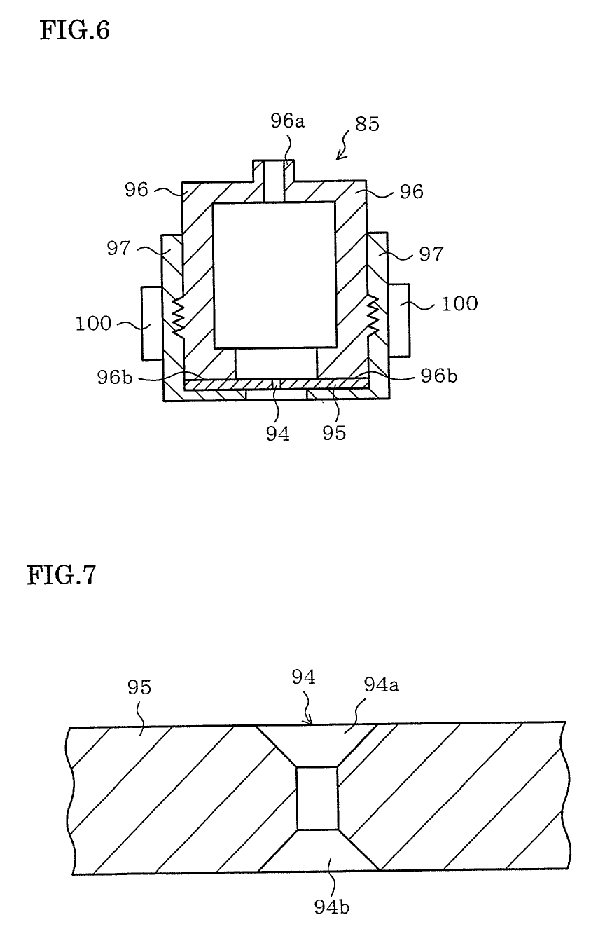

Next, the structure of the aforesaid discharge nozzle 85 will be explained in detail. The discharge nozzle 85, as shown in FIG. 6, includes a substantially cylindrical inner body 96 as a support member and a nozzle plate 95 as a thin plate for closing the bottom face of the inner body 96, and a discharge port 94 is formed at the center of the nozzle plate 95. The nozzle plate 95 is closely secured to the bottom face of the inner body 96 by an outer body 97 as a holding member which is screwed to the outside of the inner body 96.

For the nozzle plate 95, a metallic material, for example, stainless steel, with a thickness of about 0.1 mm is used and processed into a circle in outer shape. At the center of the nozzle plate 95, formed is the discharge port 94 in a predetermined size with a diameter ranging from 10 μm to 200 μm. As shown in FIG. 7, an upper face edge portion 94a of the discharge port 94 is formed in tapered shape decreasing in diameter downward, while a lower face edge portion 94b thereof is formed in tapered shape increasing in diameter downward. Moreover, the discharge port 94 has been subjected to water repellent treatment, for example, electroless nickel plating to the resist solution in use. Incidentally, a resin such as PTFE or ceramics may be used as a material of the nozzle plate 95.

The inner body 96 is formed in cylindrical shape, and the top end portion thereof includes a supply port 96a through which the resist solution is supplied from a resist solution supply source not shown. The lower end portion of the inner body 96 is an open end and closed by the aforesaid nozzle plate 95. Therefore, the resist solution supplied from the supply port 96a into the inner body 96 passes through the inner body 96 to be discharged onto the wafer W from the discharge port 94 of the nozzle plate 95 at the lower end portion.

The outer body 97 is in substantially cylindrical form with an open top. The inner shape of the outer body 97 corresponds to the outer shape of the inner body 96 to cover the outside of the inner body 96 while the lower end face 96b of the inner body 96 and the inner bottom face of the outer body 97 pushing the nozzle plate 95 from thereunder. The lower end of the outer body 97 is provided with a through hole so as not to interfere the resist solution to be discharged. Furthermore, for example, a Peltier element 100 as an electro-thermal element which is controlled by a temperature controller not shown is attached on the outer wall of the outer body 97, thereby enabling adjustment of the temperature of the nozzle plate 95 and the resist solution through the outer body 97.

Further, screws are cut in the outer face of the inner body 96 and the inner face of the outer body 97, so that the nozzle plate 95 can be removed by removing the outer body 97 from the inner body 96. Therefore, it is possible to cope speedily and easily with a situation in which the nozzle plate 95 is contaminated or a situation in which the nozzle plate 95 is exchanged with others with different diameters made of various materials or in various shapes.

The operation of thus structured resist coating unit 17 will be explained with a lithography process performed in the coating and developing system 1.

First, the wafer carrier 7 takes one unprocessed wafer W out of the cassette C and carries it into the adhesion unit 31 included in the third processing unit group G3. The wafer W coated with, for example, HMDS for reinforcing an adhesion of the resist solution is carried to the cooling unit 30 by the main carrier unit 13 and cooled to a predetermined temperature. Thereafter, the wafer W is carried to the resist coating unit 17 or 19.

The wafer W coated with the resist solution in the manner of a so-called continuous stroke described later in the resist coating unit 17 or 19 is then carried by the main carrier unit 13 to the vacuum drying unit 33, the pre-baking unit 34, and the cooling unit 40 in order. Thereafter, the wafer W is subjected to a predetermined series of treatments and processing such as exposure processing, developing treatment and the like in processing units, completing the coating and developing processing.

Explaining the operation of the aforesaid resist coating unit 17 in detail, first the wafer W which has been cooled to the predetermined temperature in the cooling unit 30 is carried into the casing 60 of the resist coating unit 17 by the main carrier unit 13. In this event, the inner case 62 in the outer case 61 previously waits at a carriage position L, and thus the wafer W is mounted directly on the mounting table 65 by the main carrier unit 13 and suction-held. At this time, a notch or an orientation flat of the wafer W is detected by the rotation mechanism 66 through the use of a not shown alignment mechanism, whereby the wafer W can be positioned at a predetermined position. Next, the inner case drive mechanism 64 moves the inner case 62 to a treatment position R. Thereafter, the mask member 70 waiting at the cleaning portion is carried from the outside of the outer case 61 into the inner case by the not shown carrier mechanism to be mounted on the mask support member 71.

Next, gas in the inner case 62 is exhausted from the exhaust ports 73 at a predetermined speed to maintain the inside the inner case 62 in a predetermined atmosphere. In the inner case 62, the discharge nozzle 85 applies the resist solution while moving relative to the wafer W to form a resist film on the wafer W.

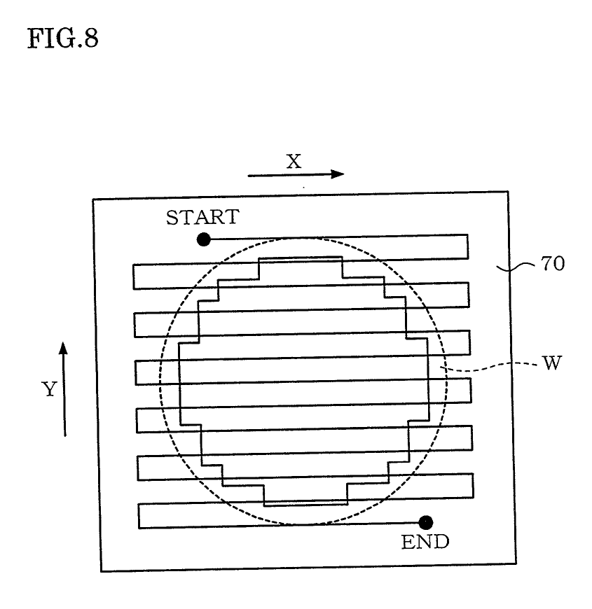

An example of a coating route (a coating trail) of the resist solution is shown in FIG. 8. For example, as shown in FIG. 8, the discharge nozzle 85 discharges the resist solution onto the wafer W while moving in the forward direction of the X-direction (the right-hand side in FIG. 8) from the START position at a predetermined speed. In this event, in the discharge nozzle 85, the resist solution sent from the not shown resist solution supply source at a predetermined pressure is supplied from the top end portion 96a of the inner body 96 and passes through the inner body 96 to be discharged from the discharge port 94 of the nozzle plate 95. Further, since the nozzle plate 95 is kept at a predetermined temperature by the Peltier element 100 attached on the outer body 97, the discharge port 94 does not change in diameter, with the result that the resist solution is discharged in thread form with a predetermined diameter from the nozzle plate 95.

It is preferable to use a resist solution diluted with a solvent as the resist solution to be discharge. For example, the resist solution is preferably diluted for use such that the volume of a resist film formation component makes up 1.5% of the resist solution. This dilution enables smooth discharge from the discharge port 94.

Thereafter, the discharge nozzle 85 travels a distance longer than the diameter of the wafer W, that is, always travels to a position beyond an end portion of the wafer W and temporarily stops above the mask member 70. In this event, the resist solution is still continuously discharged, and the resist solution discharged to places other than the wafer W is received by the mask member 70 to be drained. Then, the inner case 62 is shifted by a predetermined distance in the Y-direction by the inner case drive mechanism 64, whereby the wafer W is also shifted in the Y-direction. Thereafter, the discharge nozzle 85 returns and moves in the backward direction of the X-direction while continuously applying the resist solution, and similarly travels beyond the wafer W and stops. Then, the wafer W is shifted by the predetermined distance in the Y-direction, and the discharge nozzle 85 returns and applies the resist solution onto the wafer W.

The above-described steps are repeated, and when the discharge nozzle 85 reaches the END position shown in FIG. 8, the discharge is stopped, completing the application. Thereby, the trail of the discharge nozzle 85 becomes just as shown in FIG. 8, resulting in the application of the resist solution on the entire face of the wafer W in the manner of a so-called continuous stroke. Thereafter, the wafer W is vibrated by the high-frequency vibrator 67 attached on the mounting table 65, flatting the resist solution on the wafer W. Finally, the resist solution comes to be applied without unevenness within the coating range on the wafer W, whereby the resist film with a predetermined film thickness is formed.

Moreover, a resist solution diluted to 1.5% in concentration is used as the resist solution to be discharged, so that it is possible to form a resist film with good flatness and uniformity on the whole because even if the resist solution is applied with the wafer W being shifted in the Y-direction by the predetermined distance, the applied resist solution heaps up to a low level by virtue of its wettability and joins the resist solution which has been applied next thereto with a pitch therebetween.

After the completion of the application of the resist solution, the mask member 70 is carried out of the outer case 61 by the not shown carrier mechanism and thereafter the inner case 62 is moved to the carriage portion L by the inner case drive mechanism 64. Then, the wafer W is carried out of the casing 60 by the main carrier unit 13 and carried to the vacuum drying unit 33, in which the subsequent step is performed, to be subjected to vacuum drying processing.

The discharge nozzle 85 in the above-described embodiment has a small discharge port with a diameter of about 10 μm to 200 μm, since the discharge nozzle 85 is easy to process by virtue of the use of the nozzle plate 95 which is a stainless-steel thin plate. Consequently, the amount of application of the resist solution to other than the coating range of the wafer W is reduced, resulting in decreased amount of the resist solution required for the resist coating of the wafer W. Further, the amount of discharge or the discharge range can be controlled more precisely, resulting in improved yield. Incidentally, stainless steel is used for the aforesaid nozzle plate 95, but another metal such as aluminum, brass or the like may be used, or a non-metallic material such as a PTFE resin, ceramics, or the like is suitable.

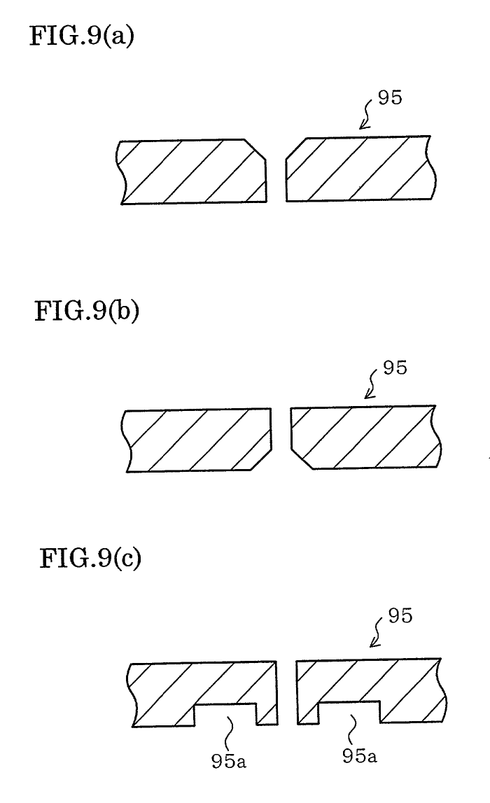

The discharge port 94 of the nozzle plate 95 is tapered at both face edge portions 94a and 94b and subjected to water repellent treatment, whereby the resist solution is discharged more smoothly and thus the diameter and the discharge direction of the discharge stream of the resist solution become stable, with the result that a predetermined resist solution is applied properly. Other than the case of tapering both face edge portions 94a and 94b of the discharge port 94, as shown in FIG. 9, it is also suitable to taper only the upper face edge portion (FIG. 9A) or only the lower face edge portion (FIG. 9B). Moreover, a recessed portion 95a may be formed in the peripheral portion of the lower face edge portion of the discharge port 94 as shown in FIG. 9C. This can suppress the influence of surface tension acting between the resist solution to be discharged and the lower face of the nozzle plate 95, supplying the resist solution to the wafer W with the discharge direction thereof stabilized.

In the above-described embodiment, the Peltier element 100 is attached to the outer body 97, whereby the resist solution flowing through the nozzle plate 95 and the inner body 96 is maintained at the predetermined temperature, stabilizing the diameter of the discharge port of the nozzle plate 95 and physical properties such as a viscosity and the like of the resist solution, with the result that a predetermined resist solution is applied properly.

The aforesaid nozzle plate 95 is convenient because when it is cleaned or when a nozzle plate 95 with a different diameter is used, replacing of the discharge nozzle 85 itself is unnecessary thanks to the nozzle plate 95 being attachable and detachable by removing the inner body 96 and the outer body 97.

As descried above, the Peltier element 100 is used to maintain the temperature of the nozzle plate 95 and the resist solution, but the temperature may be controlled by another method, for example, a thermo-module.

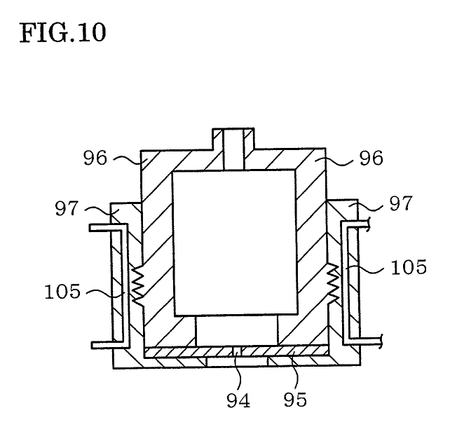

As shown in FIG. 10, the temperature may be controlled by providing a flow path 105 through which gas or liquid adjusted in temperature flows, in the outer body 97. The flow path 105 may also be installed in the inner body 96. Moreover, the aforesaid electro-thermal element such as a Peltier element may be mounted to the inner body 96. Furthermore, the electro-thermal element may also be mounted directly to the nozzle plate 95.

As for the aforesaid water repellent treatment for the nozzle plate 95, the same effect can be obtained by performing Teflon-coating or ALMITE (anode oxide coating), chromate treatment, gold plating, or silver plating for a nozzle plate made of aluminum, as a material, resulting in smooth discharge of the resist solution. Though only one discharge port 94 of the nozzle plate 95 is provided, a plurality of discharge ports may also be provided. This can avoid a reduction in coating speed due to a decrease in diameter, improving throughput.

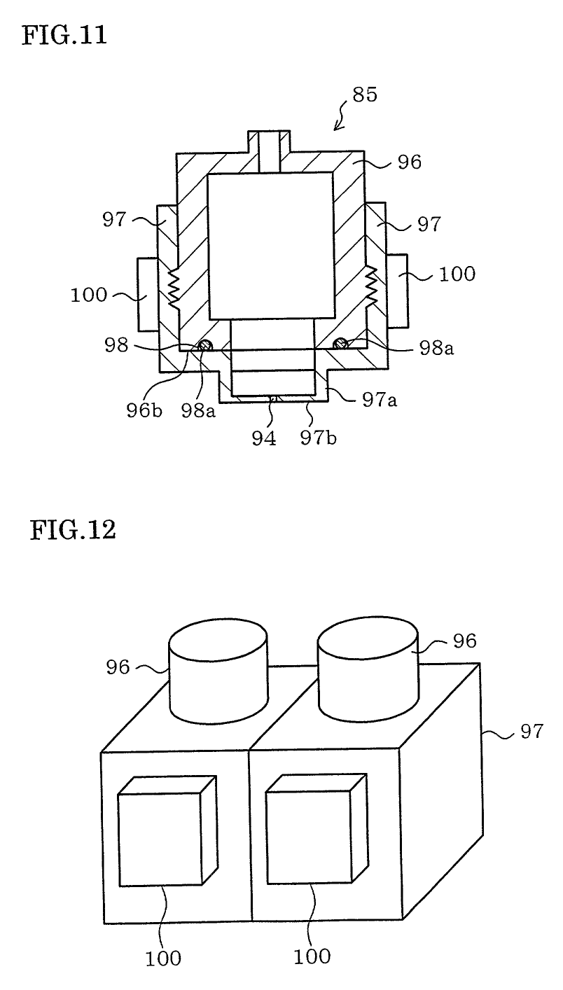

The discharge nozzle 85 shown in FIG. 11, without employing the aforesaid nozzle plate 95, is provided with a protruding portion 97a formed at the lower face of the outer body 97 made of ceramics, employs a thin plate portion 97b for the lower face of the protruding portion 97a, and is provided with the discharge port 94 formed in the thin plate portion 97b. The lower end face 96b of the inner body 96 made of PTFE is formed with an annular groove 98, and an O-ring 98a is inserted in the annular groove 98.

The discharge nozzle 85 in FIG. 11 does not employ the metallic nozzle plate, and additionally both of the inner body 96 and the outer body 97 are not made of metallic materials, never causing metallic contamination on the whole. The nozzle plate is not employed, resulting in reduced number of components. Incidentally, modifications of the above-described embodiment of the discharge port 94 can be employed, as they are, for the discharge ports 94 in various shapes.

The outer shape of the outer body 97, especially the side faces thereof, as shown in FIG. 12, are suitably in box shape. The outer shape of the outer body 97 is made in box shape, whereby when the discharge nozzle 85 is used in contact with another discharge nozzle 85 in parallel, it is easy to fix both the discharge nozzles 85 and it is possible to realize a stable fixation state.

In the above-described embodiment, the resist solution is discharged to the wafer W from thereabove, but the present invention can also be applied to the case of forming the resist film by discharging the resist solution upward from under the wafer W with the front face of the wafer W directed downward. The resist solution is applied in the manner of a so-called continuous stroke, but the present invention can also be applied to another method, for example, a spin coating method of applying the resist solution while the wafer W is rotated.

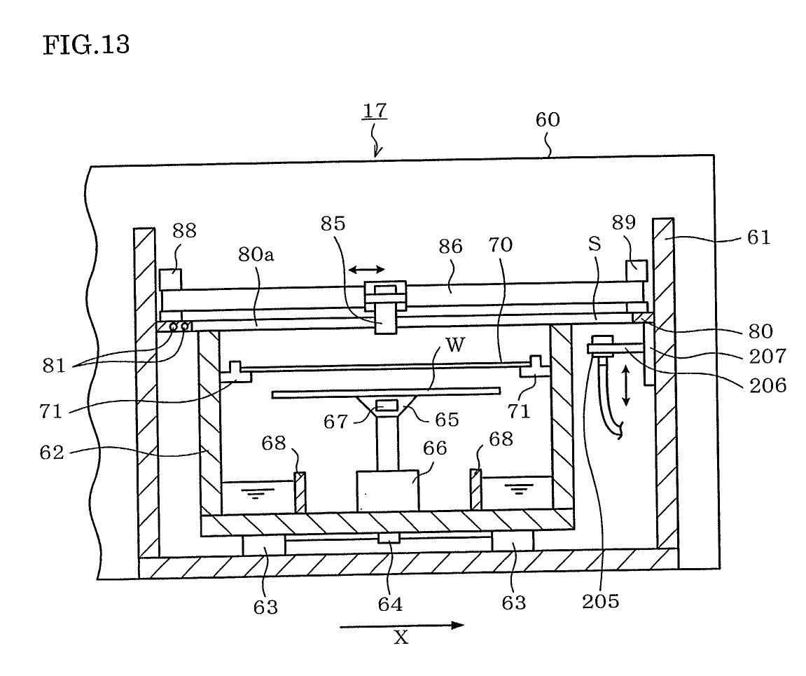

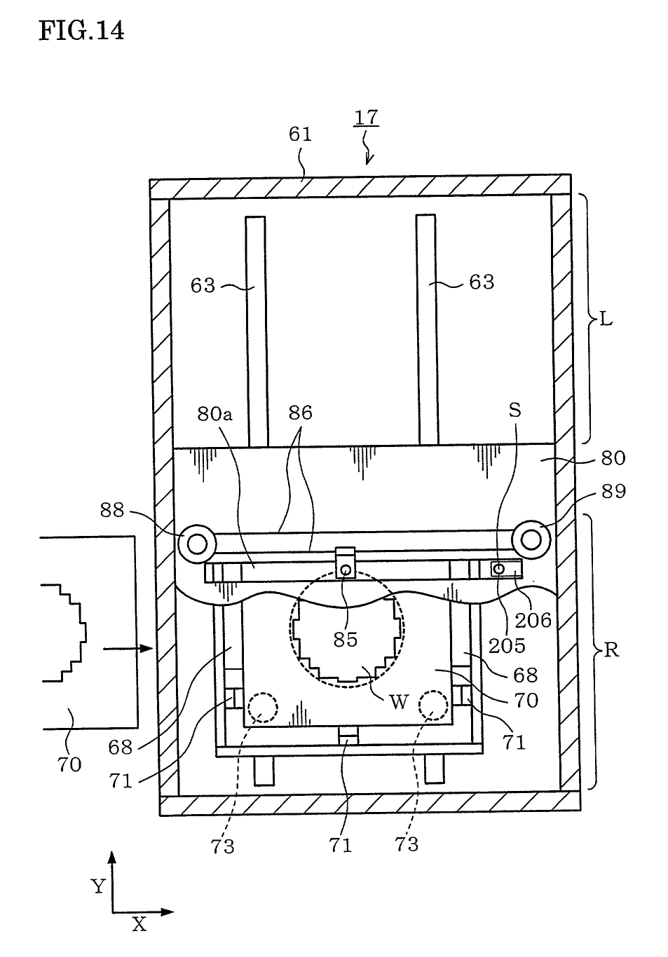

Next, another embodiment will be described. A resist coating unit 17 shown in FIG. 13 and FIG. 14 has basically the same configuration as that of the resist coating unit 17 shown in FIG. 4 and FIG. 5. A slit 80a of a lid body 80 is formed such that a discharge nozzle 85 described later can move within the range of the slit 80a. Thus, it is sufficient originally to open the slit 80a in a range of motion of the discharge nozzle 85 required for supplying the resist solution to the wafer W, that is, from one end portion to the other end portion of the diameter of the wafer W. However, in this embodiment, a cleaning block 205 for the discharge nozzle 85 described later is provided outside an inner case 62 on the forward direction side in an X-direction, and thus the length of the slit 80a is extended in the forward direction of the X-direction so that the aforesaid discharge nozzle 85 can move to a cleaning position S.

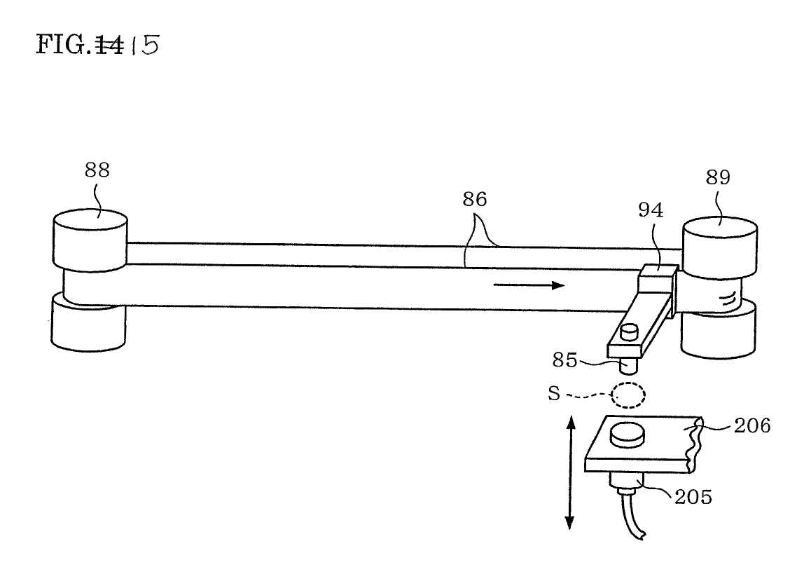

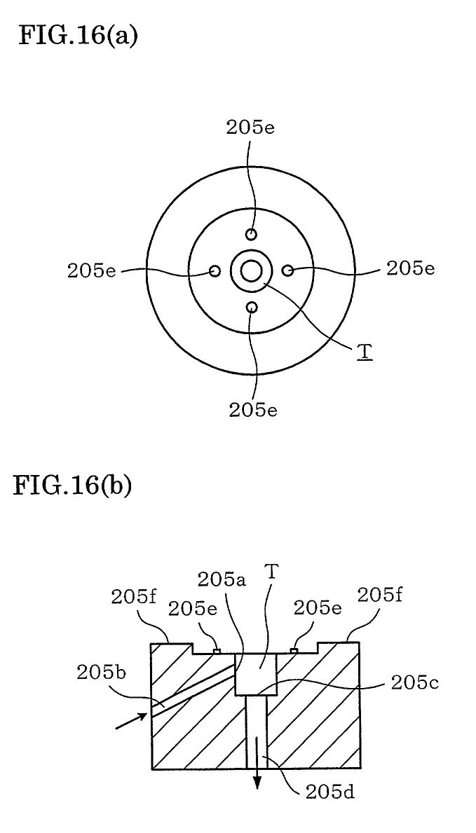

In the slit 80a of the lid body 80, the discharge nozzle 85 for discharging the resist solution is located to be capable of discharging the resist solution to the wafer W thereunder. As shown in FIG. 15, the discharge nozzle 85 is fixed to a holder 94, and the holder 94 is attached to a timing belt 86. The timing belt 86 runs between pulleys 88 and 89 provided on the lid body 80, and the pulley 88 is rotated forward and backward by a rotation mechanism such as a motor not shown. As a result, the discharge nozzle 85 can reciprocate in the slit 80a of the lid body 80 with the movement of the timing belt 86. Thus, the discharge nozzle 85 discharges the resist solution while moving relative to the wafer W thereunder, and the inner case 62 moves intermittently in a Y-direction, thereby supplying the resist solution to the entire face of the wafer W in the manner of a so-called continuous stroke. When cleaning the discharge nozzle 85, the discharge nozzle 85 can be moved to the cleaning position S outside the aforesaid inner case 62. The structure of the discharge nozzle 85 is as that shown in FIG. 6 which has already been explained.

As shown in FIG. 13 to FIG. 15, the cleaning block 205 for cleaning the discharge nozzle 85 is provided under the cleaning position S for the aforesaid discharge nozzle 85. The cleaning block 205 is held by a cleaning block holder 206, and the cleaning block holder 206 is mounted to be movable on a vertical rail 207 which is vertically provided on the inner wall of an outer case 61. Accordingly, the cleaning block 205 is vertically movable by a drive mechanism not shown.

The cleaning block 205 is, as shown in FIG, 16, formed in substantially cylindrical shape, and formed with a cleaning space T as a cleaning recessed portion at the center in the top face thereof. Further, a jet port 205a for jetting a cleaning solution is open in the side face within the cleaning space T, and a jet path 205b leading to the jet port 205a is formed inside the cleaning block 205. To the cleaning solution to be jetted into the cleaning space T applied is ultrasound by, for example, a vibrator element in a cleaning solution supply source not shown. Accordingly, the cleaning solution which has been ultrasonically vibrated is jetted from the cleaning solution supply source not shown through the jet path 205b to the cleaning space T.

A suction port 205c for sucking an atmosphere in the cleaning space T is open in the bottom face of the cleaning space T, and a suction path 205d leading to the suction port 205c is also formed inside the cleaning block 205. Therefore, the suction through the suction path 205d can make it possible to drain the cleaning solution in the cleaning space T during the cleaning and to generate airflow to speed up drying during the drying.

A plurality of protrusions 205e are provided around the cleaning space T on the top face of the cleaning block 205. By virtue of the protrusions 205e, the lower face of the outer body 97 of the discharge nozzle 85 abuts to the protrusions 205e, during the cleaning, producing a gap between the outer body 97 and the cleaning block 205. At the edge portion on the top face of the cleaning block 205 provided is a dam portion 205f in step form, which also serves a function of a cover for preventing the cleaning solution from scattering.

Through the use of the above-described resist coating unit 17 in FIG. 13 and FIG. 14, the resist solution is applied to the entire face of the wafer W in the manner of a so-called continuous stroke caused by the previous coating trail of the discharge nozzle 85 as shown in FIG. 8.

The discharge nozzle 85 used in the aforesaid coating treatment is cleaned every predetermined number of wafers W, every recipe, or every predetermined period of time.

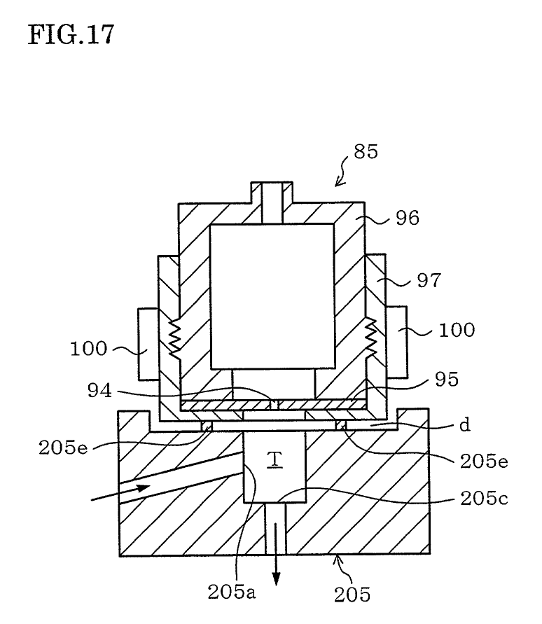

As shown in FIG. 15, the discharge nozzle 85 which has completed the coating treatment for the wafer W is moved with being held by the holder 94 to the cleaning position S by the timing belt 86 and waits there. Thereafter, the cleaning block 205 which has previously waited under the cleaning position S ascends along the vertical rail 207 shown in FIG. 13 and stops where the lower end portion (the lower face of the outer body 97) of the discharge nozzle 85 contacts the protrusions 205e of the cleaning block 205 as shown in FIG. 17. It is preferable that the center axis of the discharge nozzle 85 substantially coincides with the center axis of the cleaning block 205 such that the discharge port 94 of the discharge nozzle 85 and the cleaning space T of the cleaning block 205 face each other at this time.

Then, the cleaning solution which has been ultrasonically vibrated is supplied from the cleaning solution supply source not shown through the jet path 205b inside the cleaning block 205 to the cleaning space T. In this event, the cleaning solution is sucked from the suction port 205c for the amount of suction of the cleaning solution to coincide with the amount of supply thereof. Accordingly, the cleaning solution jetted into the cleaning space T reaches the discharge port 94 to clean the discharge port 94 and thereafter drained from the suction port 205c. The jet of the cleaning solution is stopped after the cleaning step is performed for a predetermined period of time. Meanwhile, the suction from the suction port 205c is continuously conducted. This allows the surrounding atmosphere to flow through the gap d into the vicinity of the discharge port 94 to speed up the drying of the discharge port 94. In this event, the suction speed may be increased to further speed up the drying.

After the drying step as described above is performed for a predetermined period of time, dummy dispensation of the resist solution from the discharge port 94 is performed. Subsequently, the suction from the suction port 205c is stopped, completing the cleaning and drying steps. Thereafter, the cleaning block 205 descends along the vertical rail 207 to be returned to a predetermined position. This completes a series of cleaning processes for the discharge nozzle 85.

According to the above-described embodiment, the cleaning of the nozzle plate 95 is performed by jetting the cleaning solution to the discharge port 94 of the discharge nozzle 85, so that minute contaminants can be completely removed from the discharge port 94 even if its diameter is very small. Moreover, the cleaning solution used here is ultrasonically vibrated, thereby increasing the cleaning ability. Incidentally, it is also suitable to mix air bubbles into the cleaning solution, to jet the cleaning solution intermittently, to jet the cleaning solution at high pressure, or to split the jet port into a plurality of ports to jet the cleaning solution in shower, in order to enhance its cleaning ability.

The cleaning block 205 is provided with the suction port 205c, through which the suction is conducted, thereby draining the cleaning solution during the jet of the cleaning solution, and speeding up drying during the drying. Thus, the cleaning and drying are properly performed under a simple mechanism. The provision of the protrusions 205e on the top face of the cleaning block 205 forms the gap d between the cleaning block 205 and the discharge nozzle 85, whereby the performance of the suction from the suction port 205c allows the surrounding air to be taken in through the gap d, with the result that the surrounding air is used as a drying air.

The cleaning block 205 is placed within the range of motion of the aforesaid discharge nozzle 85, that is, under the cleaning position S in the slit 80a, and is provided to be vertically movable, eliminating the necessity of separately providing a mechanism for carrying the discharge nozzle 85 itself or the necessity of carrying the discharge nozzle 85 to a predetermined position to be cleaned. In the above-described embodiment, the original slide range of the discharge nozzle 85 is extended to provide the cleaning block 205 at the slit 80a end (the cleaning position S) and the cleaning block 205 is vertically moved. However, the cleaning block 205 may be supported by a proper arm as carrier means and the arm may be provided in the slit 80a to be movable. It is also suitable to make the width of the slit 80a equal to the range required originally for the coating of the wafer W and to move the arm supporting the cleaning block 205 within this range. Further, the mounting position of the arm is not limited to the inner wall of the outer case 61, but it may be provided on the inner wall of the inner case 62.

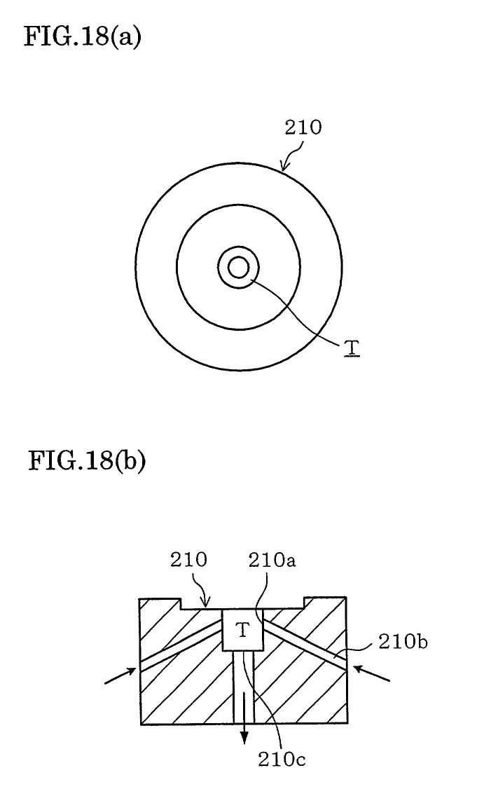

The cleaning block 205 in the above-described embodiment may be provided with gas supply means for supplying an inert gas for drying the discharge port 94. More specifically, as shown in FIG. 18, a gas supply port 210a which is open in a side wall within the cleaning space T of a cleaning block 210 is provided in the cleaning block 210, and a gas supply path 210b leading to the gas supply port 210a is provided inside the cleaning block 210. Protrusions 205e may be provided on the top face of the cleaning block 210 as in the cleaning block 205, but that is not an absolute necessity because gas for drying is positively supplied through the use of the gas supply port 210a and the gas supply path 210b. After the completion of the cleaning step as in the above-described embodiment, an inert gas, for example, nitrogen gas, may be supplied from the gas supply port 210a into the cleaning space T and exhausted from a suction port 210c to thereby dry the nozzle plate 95.

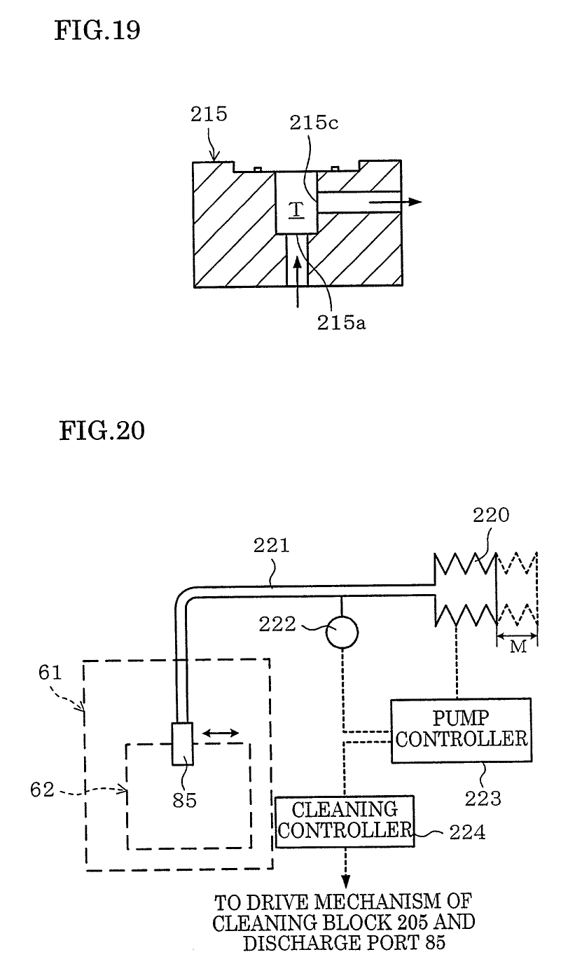

In the above-described embodiment, the cleaning solution is jetted from the side face within the cleaning space T, and the cleaning solution, the atmosphere, and the like are sucked from the bottom of the cleaning space T. However, as shown in FIG. 19, a jet port 215a for the cleaning solution may be provided in the bottom face within the cleaning space T of a cleaning block 215, and a suction port 215c for sucking the cleaning solution and the like may be provided in the side face within the cleaning space T. This example has a high cleaning effect because it can jet the cleaning solution with opposing the discharge port 94 of the discharge nozzle 85 so that the jet pressure of the cleaning solution is exerted on the discharge port 94 as it is.

In this case, the exhaust pressure from the suction port 215c is made higher than the jet pressure from the jet port 215a to bring about suction of a remaining solution from the discharge port of the discharge nozzle 85, making it possible to realize the cleaning of the discharge port 94 more securely.

The discharge nozzle 85 in the above-described embodiment is provided with the outer body 97 as a holding member, but the cleaning block 205 may be closely attached directly to the lower face of the nozzle plate 95 in the case where the outer body 97 is not provided and the nozzle plate 95 is fixed directly to the inner body 96.

The cleaning in the aforesaid embodiment is performed, as described above, at the previously set timing such as every number of wafers W or every predetermined period of time, but the cleaning may be performed only when the discharge port 94 of the discharge nozzle 85 is contaminated. Hereinafter, a unit for detecting that the discharge port 94 is contaminated will be explained.

In an example shown in FIG. 20, a diaphragm-type pump 220 is used as supply means for supplying the resist solution to the aforesaid discharge nozzle 85, and a pressure gage 222 for measuring a discharge pressure is provided on a supply pipe 221 extending to the discharge nozzle 85. A pump controller 223 for controlling the pump 220 based on a measurement value by the pressure gage 222 is provided, so that the pump 220 is controlled by the pump controller 223 to always keep the discharge pressure of the resist solution constant. The pump 220 is of a diaphragm type, it changes a forcing amount M based on the measurement value of the aforesaid pressure to keep the discharge pressure of the resist solution constant. There provided is a cleaning controller 224 for commanding a drive mechanism of the cleaning block 205 and the discharge nozzle 85 to start the cleaning with a trigger that the discharge port 94 is contaminated and the forcing amount M changes greater than a predetermined value.

In the pump controller 223 installed is a detecting function as detection means for storing various kinds of properties of the resist solution, for example, the forcing amount M of the pump 220 to a viscosity and calculating its amount of change N to calculate the amount of change N at any time. The forcing amount M for keeping the pressure in the supply pipe 221 constant usually increase at a fixed speed, and thus the aforesaid amount of change N of the pump 220 is fixed. However, when the discharge nozzle 85 is contaminated and thus the resist solution becomes hard to be discharged, the speed of the forcing amount M of the pump 220 is reduced by the pump controller 223 to keep the pressure in the supply pipe 221 constant. At this time, the aforesaid amount of change N of the pump 220 changes.

A signal of the change is sent to the cleaning controller 224 and the drive mechanism of the cleaning block 205 and the discharge nozzle 85 is started by the command from the cleaning controller 224 to start the cleaning treatment of the discharge nozzle 85 as described above. Therefore, the timing of contamination, that is, the timing of cleaning can be detected by calculating and observing the amount of change N at any time.

Even if the pump 220 is not of a diaphragm type, but, for example, of a rotation-type pump, the cleaning timing can be similarly detected by observing an amount of change in number of rotation of the pump and an amount of change in power consumption.

Further, the discharge nozzle 85 is directly observed to detect the cleaning timing based on its image data. This case can be realized by, for example, mounting a CCD camera for observing the discharge port 94 of the discharge nozzle 85 and allowing it to observe at any time.

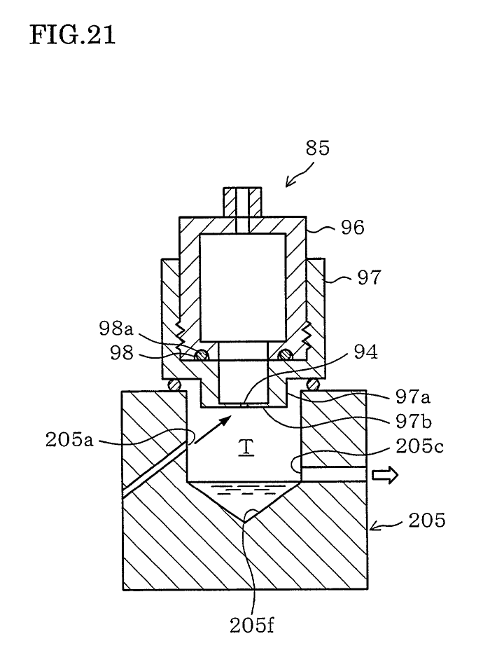

A discharge nozzle 85 shown in FIG. 21 does not have a nozzle plate, but has a protruding portion 97a formed at the lower face of an outer body 97 made of ceramics, employs a thin plate portion 97b for the lower face of the protruding portion 97a, and has a discharge port 94 formed in the thin plate portion 97b. An annular groove 98 is formed in a lower end face 96b of an inner body 96 made of PTFE, and an O-ring 98a is inserted in the annular groove 98.

The discharge nozzle 85 in FIG. 21 does not employ the metallic nozzle plate, and additionally both of the inner body 96 and the outer body 97 are not made of metallic materials, never causing metallic contamination on the whole. The nozzle plate is not employed, resulting in reduced number of components. The outer shape of the outer body 97, especially the side faces are suitably in box shape. The outer shape of the outer body 97 is made in box shape, whereby when the discharge nozzle 85 is used in contact with another discharge nozzle 85 in parallel, it is easy to fix both the discharge nozzles 85 and it is possible to realize a stable fixation state.

In a cleaning clock 205 shown in FIG. 21, a suction port 205c is formed horizontally. The bottom face of the cleaning space T forms an inverted cone shape and is formed with a cleaning solution store portion 205g. Therefore, the cleaning solution stays in the store portion 205g, preventing drying of the discharge port 94 of the discharge nozzle 85 with its vapor.

In the above-described embodiments, the resist solution is applied in the manner of a so-called continuous stroke, but the present invention can also be applied to another method, for example, a spin coating method of applying the resist solution while the wafer W is rotated or the like.

The above-described embodiments are film forming apparatuses each for applying the resist solution to the wafer W to form a resist film, but the present invention can also be applied to another film forming apparatus for an insulating film, for example, an SOD or SOG film forming apparatus. Further, the present invention can also be applied to a film forming apparatus for a substrate other than a wafer W, for example, for an LCD substrate.

The above embodiments facilitate the understanding of the present invention. The present invention, however, is not intended to be interpreted limited to the above embodiments. Various modifications and changes made without departing from the spirit of the present invention are understood to be included in the range of the present invention.

What is claimed is:

1. A film forming apparatus for supplying a coating solution from a discharge nozzle to a substrate to form a film on a front face of said substrate,
wherein said discharge nozzle comprises a substantially cylindrical support member and a thin plate, supported on a face on a substrate side of said support member, for closing the face on the substrate side, and
wherein said thin plate is provided with a discharge port for discharging said coating solution to said substrate.

2. An apparatus as set forth in claim 1, further comprising:
a holding member for fixing said thin plate to said support member from the outside.

3. An apparatus as set forth in claim 2,
wherein an edge portion of a face on the substrate side of said discharge port is formed such that said discharge port increases in diameter as it comes closer to said substrate.

4. An apparatus as set forth in claim 2,
wherein an edge portion of a face on the opposite side to a face on the substrate side of said discharge port is formed such that said discharge port decreases in diameter as it comes closer to said substrate.

5. An apparatus as set forth in claim 2,
wherein a recessed portion is formed in a peripheral portion of an edge portion of the face on the substrate side of said discharge port.

6. An apparatus as set forth in claim 2,
wherein at least said discharge port has been subjected to water repellent treatment to said coating solution.

7. An apparatus as set forth in claim 2,
wherein said thin plate is attachable and detachable to/from said support member.

8. An apparatus as set forth in claim 2,
wherein a plurality of said discharge ports are provided in said thin plate.

9. An apparatus as set forth in claim 2,
wherein said discharge nozzle is movable in a horizontal direction with respect to said substrate.

10. An apparatus as set forth in claim 2, further comprising:
a temperature regulator capable of adjusting temperature of said thin plate.

11. An apparatus as set forth in claim 2,
wherein said support member is provided with a flow path through which a fluid for adjusting temperature flows.

12. An apparatus as set forth in claim 2,
wherein said holding member is provided with a flow path through which a fluid for adjusting temperature flows.

13. An apparatus as set forth in claim 10,
wherein said temperature regulator is an electro-thermal element, and said electro-thermal element is provided in contact with said support member or said holding member.

14. An apparatus as set forth in claim 2,
wherein said coating solution is a coating solution for forming a photoresist, an amount of a photoresist film formation component in said coating solution being 1.0% to 7.0% of said coating solution.

15. An apparatus as set forth in claim 2,
wherein said coating solution is a coating solution for forming a layer insulating film, an amount of a layer insulating film formation component in said coating solution being 1.0% to 8.0% of said coating solution.

16. An apparatus as set forth in claim 2,
wherein said holding member has side faces in box shape.

17. A film forming apparatus for supplying a coating solution from a discharge nozzle to a substrate to form a film on a front face of said substrate,
wherein said discharge nozzle comprises a substantially cylindrical support member and a thin plate portion, disposed on a face on a substrate side of said support member, for closing the face on the substrate side,
wherein said thin plate portion is integrated with a holding member which is attachable and detachable to/from said support member, and
wherein said thin plate portion is provided with a discharge port for discharging said coating solution to said substrate.

18. An apparatus as set forth in claim 17,
wherein an edge portion of a face on the opposite side to a face on the substrate side of said discharge port is formed such that said discharge port decreases in diameter as it comes closer to said substrate.

19. An apparatus as set forth in claim 17,
wherein a recessed portion is formed in a peripheral portion of an edge portion of the face on the substrate side of said discharge port.

20. An apparatus as set forth in claim 17,
wherein at least said discharge port has been subjected to water repellent treatment to said coating solution.

21. An apparatus as set forth in claim 17,
wherein a plurality of said discharge ports are provided in said thin plate portion.

22. An apparatus as set forth in claim 17,
wherein said discharge nozzle is movable in a horizontal direction with respect to said substrate.

23. An apparatus as set forth in claim 17, further comprising:
a temperature regulator capable of adjusting temperature of said thin plate portion.

24. An apparatus as set forth in claim 17,
wherein said support member is provided with a flow path through which a fluid for adjusting temperature flows.

25. An apparatus as set forth in claim 17,
wherein said holding member is provided with a flow path through which a fluid for adjusting temperature flows.

26. An apparatus as set forth in claim 23,
wherein said temperature regulator is an electro-thermal element, and said electro-thermal element is provided in contact with said support member or said holding member.

27. An apparatus as set forth in claim 17,
wherein said coating solution is a coating solution for forming a photoresist, an amount of a photoresist film formation component in said coating solution being 1.0% to 7.0% of said coating solution.

28. An apparatus as set forth in claim 17,
wherein said coating solution is a coating solution for forming a layer insulating film, an amount of a layer insulating film formation component in said coating solution being 1.0% to 8.0% of said coating solution.

29. A film forming apparatus for supplying a coating solution from a discharge nozzle to a substrate to form a film on a front face of said substrate, comprising:
a cleaning device for cleaning said discharge nozzle,
said cleaning device comprising a cleaning solution jet port for jetting a cleaning solution for cleaning to a discharge port of said discharge nozzle and a suction port for sucking an atmosphere in the vicinity of said discharge port.

30. A film forming apparatus for supplying a coating solution from a discharge nozzle to a substrate to form a film on a front face of said substrate, comprising:
a cleaning device for cleaning said discharge nozzle,
said discharge nozzle comprising a substantially cylindrical support member, a thin plate provided on a lower face of said support member for closing the lower face, and a discharge port formed in said thin plate,
said cleaning device comprising a cleaning block including a flat close contact portion closely contacting said thin plate at an upper end,
wherein said cleaning block is provided with a cleaning solution jet port for jetting a cleaning solution toward said discharge port of said discharge nozzle and a suction port for sucking an atmosphere in the vicinity of said discharge port when said cleaning block closely contacts said thin plate.

31. A film forming apparatus for supplying a coating solution from a discharge nozzle to a substrate to form a film on a front face of said substrate, comprising:
a cleaning device for cleaning said discharge nozzle,
said discharge nozzle comprising a substantially cylindrical support member, a thin plate provided on a lower face of said support member for closing the lower face, a discharge port formed in said thin plate, and a holding member for fixing said thin plate to said support member from the outside,
said cleaning device comprising a cleaning block including a flat close contact portion closely contacting said holding member at an upper end,
wherein said cleaning block is provided with a cleaning solution jet port for jetting a cleaning solution toward said discharge port of said discharge nozzle and a suction port for sucking an atmosphere in the vicinity of said discharge port when said cleaning block closely contacts said holding member.

32. A film forming apparatus for supplying a coating solution from a discharge nozzle to a substrate to form a film on a front face of said substrate, comprising:
a cleaning device for cleaning said discharge nozzle in contact with said discharge nozzle,
said discharge nozzle comprising a substantially cylindrical support member, a thin plate supported on a lower face of said support member for closing the lower face, and a discharge port with a predetermined diameter formed in said thin plate,
said cleaning device comprising a cleaning block including protrusions on a face contacting said thin plate,
wherein said cleaning block is provided with a cleaning solution jet port for jetting a cleaning solution toward said discharge port of said discharge nozzle and a suction port for sucking an atmosphere in the vicinity of said discharge port when said cleaning block contacts said thin plate via said protrusions.

33. A film forming apparatus for supplying a coating solution from a discharge nozzle to a substrate to form a film on a front face of said substrate, comprising:
a cleaning device for cleaning said discharge nozzle in contact with said discharge port,
said discharge nozzle comprising a substantially cylindrical support member, a thin plate supported on a lower face of said support member for closing the lower face, a discharge port formed in said thin plate, and a holding member for fixing said thin plate to said support member from the outside,
said cleaning device comprising a cleaning block including protrusions on a face contacting said holding member,
wherein said cleaning block is provided with a cleaning solution jet port for jetting a cleaning solution toward said discharge port of said discharge nozzle and a suction port for sucking an atmosphere in the vicinity of said discharge port when said cleaning block contacts said holding member via said protrusions.

34. An apparatus as set forth in claim 31,
wherein said thin plate is integral with said holding member in structure.

35. An apparatus as set forth in claim 34,
wherein a sealing member is interposed between said holding member and said close contact portion.

36. An apparatus as set forth in claim 33,
wherein said thin plate is integral with said holding member in structure.

37. An apparatus as set forth in claim 30,
wherein a cleaning recessed portion is formed at the center in a top portion of said cleaning block, and
wherein said jet port and said suction port are open in said cleaning recessed portion.

38. An apparatus as set forth in claim 37,
wherein a jet path leading to said jet port and a suction path leading to said suction port are formed inside said cleaning block.

39. An apparatus as set forth in claim 37,
wherein said cleaning block comprises a gas supply mechanism for supplying an inert gas for drying toward said discharge port of said discharge nozzle, and
wherein a supply port of said inert gas is open in said cleaning recessed portion.

40. An apparatus as set forth in claim 39,
wherein a jet path leading to said jet port, a suction path leading to said suction port, and a supply path leading to said supply port are formed inside said cleaning block.

41. An apparatus as set forth in claim 39,
wherein said inert gas is set at a predetermined temperature.

42. An apparatus as set forth in claim 34,
wherein said jet port is formed at a position opposing said discharge port of said discharge nozzle.

43. An apparatus as set forth in claim 34,
wherein said suction port is formed at a position opposing said discharge port of said discharge nozzle.

44. An apparatus as set forth in claim 30,
wherein said discharge nozzle is movable relative to said substrate, and
wherein said cleaning block is disposed within a range of motion of said discharge nozzle and vertically movable.

45. An apparatus as set forth in claim 30,
wherein said discharge nozzle is movable relative to said substrate, and
wherein said cleaning block is held by a carrier mechanism movable within a range of motion of said discharge nozzle, and said carrier mechanism is vertically movable.

46. An apparatus as set forth in claim 29,
wherein ultrasound is applied to said cleaning solution to be jetted.

47. An apparatus as set forth in claim 29,
wherein air bubbles are mixed into said cleaning solution to be jetted.

48. An apparatus as set forth in claim 29,
wherein said cleaning solution to be jetted is intermittently jetted.

49. An apparatus as set forth in claim 29,
wherein a plurality of jet ports for jetting said cleaning solution are provided.

50. An apparatus as set forth in claim 29, further comprising:
a diaphragm-type pump for supplying said coating solution to said discharge nozzle;
a detecting function unit for detecting a change in forcing amount of said pump; and
a cleaning controller for causing said cleaning device to start cleaning based on a detection result by said detecting function unit.

51. An apparatus as set forth in claim 29,
wherein said cleaning block is provided with a cover for covering at least a lower periphery of said discharge nozzle.
